(19) United States
(12) Patent Application Publication
(10) Pub. No.: US 2015/0155535 A1
(43) Pub. Date: Jun. 4, 2015

(54) SEALED SECONDARY BATTERY

(71) Applicant: PANASONIC INTELLECTUAL PROPERTY MANAGEMENT CO., LTD., Osaka (JP)

(72) Inventors: Masato Fujikawa, Osaka (JP); Akihiro Maeda, Osaka (JP); Tomohiko Yokoyama, Osaka (JP); Keisuke Shimizu, Osaka (JP)

(21) Appl. No.: 14/411,891

(22) PCT Filed: Jul. 2, 2013
(86) PCT No.: PCT/JP2013/004098

§ 371 Date: Dec. 29, 2014

(30) Foreign Application Priority Data
Jul. 2, 2012 (JP) 2012-148238

(51) Int. Cl. H01M 2/12

(52) U.S. Cl. CPC H01M 2/1223

(57) ABSTRACT

Disclosed is a sealed secondary battery including: a case having an opening, and housing an electrode group including a positive electrode, a negative electrode, and a separator; an insulating plate disposed near the opening and between the opening and the electrode group within the case; and a sealing unit sealing the opening of the case. The sealing unit includes a first conductor plate, a second conductor plate, and a valve mechanism interposed therebetween. The first conductor plate is disposed on the exterior side of the case, and the second conductor plate is disposed on the interior side of the case. The first conductor plate has a first hole having an opening area S1 (mm²), the insulating plate has a second hole having an opening area S2 (mm²), and S1 and S2 satisfy the inequality: (3/t+12) mm²≦S1<S2, where a coefficient t corresponds to a wall thickness (mm) of the case.

### TECHNICAL FIELD

The present invention relates to a sealed secondary battery, particularly to an improvement of a sealed secondary battery provided with a valve mechanism for discharging gas generated within the battery to the exterior.

### BACKGROUND ART

In sealed secondary batteries with high energy density (e.g., lithium ion secondary batteries), in the event of an internal short circuit or external short circuit, a vigorous reaction occurs, and a large amount of gas may be generated within the battery. In other cases, for example, when such secondary batteries are heated to a high temperature or subjected to a large impact, a vigorous reaction occurs, and a large amount of gas may be generated within the battery. If, as a result, the internal pressure of the battery case increases sharply, the case may deform significantly. To prevent such inconvenience, sealed secondary batteries whose energy density is particularly high are provided with a valve mechanism that acts to quickly discharge the gas generated within the battery to the exterior and suppress an increase in the internal pressure of the battery case.

A brief description is given below of the structure or production method of sealed secondary batteries. For example, a cylindrical battery includes an electrode group formed by spirally winding plate-like or sheet-like positive and negative electrodes, with a separator interposed therebetween. The electrode group is, together with electrolyte, housed in a battery case. A flat or prismatic battery includes an electrode group formed by, for example, stacking positive and negative electrodes, with a separator interposed therebetween.

After the electrode group and the electrolyte are housed in the battery case, the opening of the battery case is sealed with a sealing unit. Typically, the sealing unit has a valve mechanism. The positive electrode is connected to, for example, the sealing unit via a positive electrode lead, and the negative electrode is connected to, for example, the bottom of the battery case via a negative electrode lead. In this configuration, the sealing unit functions as a positive terminal of the battery, and the battery case functions as a negative terminal.

Insulating plates are respectively disposed on top and bottom of the electrode group within the battery case (“top” is the side near the opening, and “bottom” is the side near the bottom of the battery case). The insulating plates disposed on top and bottom of the electrode group restrict a movement of the electrode group within the battery case and prevent a deformation of the electrode group. This can prevent a contact of the positive electrode with the negative electrode lead and other similar problems.

For sealed secondary batteries in which a valve mechanism is included in the sealing unit, it is important to sufficiently quickly discharge the gas within the battery case to the exterior. Particularly when the energy density of the battery is high, an abrupt gas generation occurs in the event of an abnormality such as an internal short circuit. This is followed by a sharp increase in the internal pressure of the battery case, which may result in a significant deformation of the case. Therefore, it is expected to sufficiently ensure the gas discharge ability of the valve mechanism, so that the case internal pressure increased sharply in the event of an abnormality can be lowered quickly.

In connection with the above problem, Patent Literature 1 proposes optimizing the area of a vent hole provided in an insulating plate on top of the electrode group within the battery case (hereinafter referred to as “upper insulating plate”), thereby to allow the valve mechanism to function effectively.

### CITATION LIST

### Patent Literature

[PTL 1] Japanese Laid-Open Patent Publication No. 2007-294440

### SUMMARY OF INVENTION

### Technical Problem

To sufficiently ensure the gas discharge ability of the valve mechanism provided in the sealing unit, it is undoubtedly important to provide a vent hole having an appropriate area in the upper insulating plate. However, optimizing the area of the vent hole of the upper insulating plate is not enough to sufficiently ensure the gas discharge ability of the valve mechanism. Further examination on each element constituting a gas escape route is required.

The present invention has been made in view of the above problems, and a main objective is to ensure a satisfactory gas discharge ability in a sealed secondary battery having a valve mechanism.

### Solution to Problem

The present invention provides a sealed secondary battery including:

an electrode group including a positive electrode, a negative electrode, and a separator;

a case housing the electrode group and having an opening;

an insulating plate disposed near the opening and between the opening and the electrode group within the case; and

a sealing unit sealing the opening of the case.

The sealing unit includes a first conductor plate, a second conductor plate, and a valve member interposed between the first conductor plate and the second conductor plate, and is fitted to the opening of the case, with the first conductor plate disposed on the exterior side of the case and the second conductor plate disposed on the interior side of the case.

The first conductor plate has a first hole for passage of gas.

The insulating plate has a second hole for passage of gas.

The first hole has an opening area S1 (mm²), the second hole has an opening area S2 (mm²), and S1 and S2 satisfy the following inequality:

(3/t+12)mm²≦S1<S2,

where a coefficient t corresponds to a wall thickness (mm) of the case.

### Advantageous Effects of Invention

According to the present invention, when the internal pressure of the battery case increases sharply, the gas generated within the battery can be quickly discharged to the exterior. This can improve the safety of the sealed secondary battery.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

FIG. 1 A schematic cross-sectional view of a sealed secondary battery according to one embodiment of the present invention.

FIG. 2 A graph showing a relationship among the gas discharge ability of a valve mechanism included in a sealing unit provided in the sealed secondary battery, the opening area S1 of a first hole of a first conductor plate, and the wall thickness of a case.

### DESCRIPTION OF EMBODIMENTS

A sealed secondary battery of the present invention includes: a case having an opening, and housing an electrode group including a positive electrode, a negative electrode, and a separator; an insulating plate disposed near the opening and between the opening and the electrode group within the case; and a sealing unit sealing the opening of the case. The sealing unit includes a first conductor plate, a second conductor plate, and a valve member interposed therebetween. The sealing unit is fitted to the opening of the case, with the first conductor plate disposed on the exterior side of the case and the second conductor plate disposed on the interior side of the case. The first conductor plate has a first hole for passage of gas. Likewise, the insulating plate has a second hole for passage of gas. The first hole has an opening area S1 (mm²), the second hole has an opening area S2 (mm²), and S1 and S2 satisfy the following inequality:

(3/t+12)mm²≦S1<S2,

where a coefficient t corresponds to a wall thickness (mm) of the case. Note that when the wall thickness of the case varies from portion to portion of the case (e.g., different between at the side wall and at the bottom), the coefficient t is preferably set with reference to, for example, the thickness of the side wall.

As shown in the above inequality, in the present invention, a lower limit value LV (=3/t+12) of the opening area S1 of the first hole provided in the first conductor plate is set depending on the wall thickness (coefficient t) of the case. The opening area S2 of the second hole provided in the insulating plate is set larger than the opening area S1 of the first conductor plate. By doing as above, the opening areas of the first hole and the second hole can be set appropriately in correspondence with the strength of the case. This is because the strength of the case is greatly dependent on its wall thickness.

According to the present invention, the first hole and the second hole each having an appropriate opening area can be provided in their corresponding members (first conductor plate, insulating plate), so that the gas within the case can be quickly discharged through the valve mechanism without causing extreme deformation of the case. By providing such first and second holes in their corresponding members, the valve mechanism can exert a satisfactory gas discharge ability, making it possible to sufficiently ensure the safety of the sealed secondary battery. Furthermore, the opening area S1 can be set to a minimum necessary area, and thereby the above effect can be obtained without scarifying the intrinsic function of each member. For example, the reduction in the strength of the first conductor plate constituting the sealing unit can be minimized.

The first conductor plate is, among the sealing unit, disposed nearest to the exterior of the case. Therefore, the first conductor plate usually serves as a positive (external) terminal of the battery. Accordingly, the first conductor plate undergoes external forces of various magnitudes. It is therefore expected to form the first conductor plate to have a strength of a certain level or higher. In doing so, if the opening area S1 of the first hole is excessively large, such strength is difficult to ensure. For this reason, an upper limit value UV of the opening area S1 is preferably set to a smaller one between the following two: an area which is 5% of a plane view area PS (e.g., projection area viewed from the opening of the battery) of the first conductor plate, and an area which is 1.6 times as large as the lower limit value LV. Therefore, the opening area S1 preferably satisfies the inequality: (3/t+12) mm²≦S1≦0.05×PS, or (3/t+12) mm²≦S1≦1.6×(3/t+12) mm². With respect to an upper limit of the opening area S2, it may be set to any value within the range that does not damage the function of the insulating plate to provide insulation in the case.

By setting the opening area S2 larger than the opening area S1, the gas can be quickly discharged without sacrificing the effect obtained by providing the first hole having an adequate opening area S1 in the first conductor plate. In addition, when the internal pressure of the case increases sharply in the event of an abnormality such as an internal short circuit, the valve mechanism can quickly sense the increase in pressure. This can activate the valve mechanism without delay and can quickly lower the internal pressure of the case.

In one embodiment of the present invention, the coefficient t corresponds to the wall thickness of the case of 0.1 mm or more and 0.25 mm or less. The present invention is particularly effective with respect to a sealed secondary battery including a case having a wall thickness within the above range. To impart the case with a strength that does not cause extreme deformation of the case when its internal pressure increases abnormally, the thickness of the case is preferably set to 0.1 mm or more. The volume of the case, however, decreases with increases in the wall thickness of the case. An excessive increase of the wall thickness of the case, therefore, may result in a failure of obtaining a desirable energy density of the sealed secondary battery. Therefore, the wall thickness of the case is preferably 0.25 mm or less.

In one embodiment of the present invention, the first conductor plate and the valve plate each include aluminum, and the second conductor plate includes iron or stainless steel. A preferable material of the case is, for example, iron or stainless steel.

A sealed secondary battery whose energy density is as high as 600 Wh/L or more is likely to cause extreme deformation of the case due to an increase in the case internal pressure. Therefore, the necessity of applying the present invention to such a battery is high. Hence, the present invention is particularly effective for a battery including a case having a cylindrical shape. When the case is cylindrical, it is easy to raise the proportion of the electrode group to the internal volume of the case, and is easy to provide a sealed secondary battery with higher energy density. Furthermore, the present invention is particularly suitable for a cylindrical battery (18650-size cylindrical battery) including a case having a diameter of 17.8 to 18.5 mm and an overall height of 64.0 to 65.2 mm.

In the following, an embodiment of the present invention will be specifically described with reference to the drawings. The following embodiment, however, should not be construed as limiting the present invention. Modifications can be made appropriately to the embodiment without departing from the scope of the present invention. Further, the present embodiment can be combined with another embodiment, or other embodiments can be combined together.

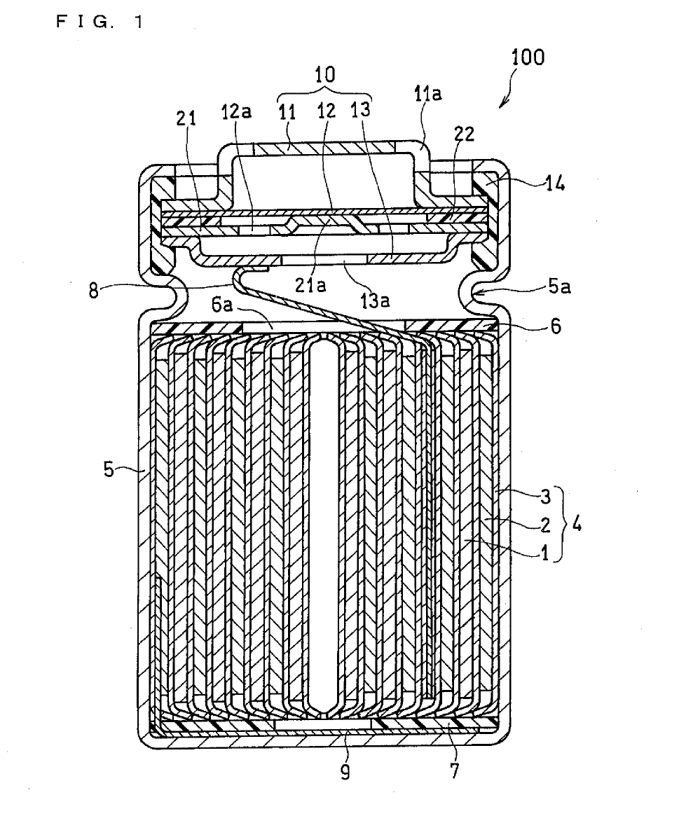

FIG. 1 is a schematic cross-sectional view of a sealed secondary battery according to the present embodiment. A battery 100 illustrated in FIG. 1 is one example of sealed secondary batteries and includes an electrode group 4 formed by winding a positive electrode 1 and a negative electrode 2, with a separator 3 interposed therebetween. The electrode group 4 is housed in a case 5, together with an electrolyte (not shown). The opening of the case 5 is sealed with a sealing unit 10 via a gasket 14.

The sealing unit 10 is a stack of a first conductor plate 11 which is a terminal plate having a hat-like cross section, a valve member 12 which is a constituent element of a valve mechanism, and a saucer-like second conductor plate 13. FIG. 1 exaggerates the height of the protrusion of the first conductor plate 11. Actually, the first conductor plate 11 is almost flat, and the area of a first hole 11a is nearly the same as the projection area of the first hole 11a viewed from the opening of the battery. The first conductor plate 11 positive electrode 1 is connected to the second conductor plate 13 via a positive electrode lead 8. The negative electrode 2 is connected to the bottom of the case 5 via a negative electrode lead 9. On top and bottom of the electrode group 4 (“top” is the side near the opening, and “bottom” is the side near the bottom), an insulating plate 6 also referred to as “upper insulating plate” and an insulating plate 7 also referred to as “lower insulating plate” are disposed, respectively. The upper insulating plate 6 is secured in place by a groove 5a formed on the side wall of the case 5 so as to protrude inward.

The first conductor plate 11 is provided with the first hole 11a for passage of gas to be discharged through the valve mechanism. The second conductor plate 13 is provided with a vent hole 13a. The insulating plate 6 is provided with a second hole 6a for passage of gas to be discharged through the valve mechanism. The valve mechanism is formed by welding the valve member 12 made of, for example, a circular thin metal sheet, to a valve substrate 21 at their center portions. The peripheral portion of the valve member 12 is secured in place between the peripheral portion of the valve substrate 21 and the peripheral portion of the first conductor plate 11 via a donut disc-shaped PTC (positive temperature coefficient) element plate 22. The valve substrate 21 has in its center portion, at least one vent hole 12a and a welding portion 21a to which the valve member 12 is welded. By configuring as above, when the internal pressure of the case 5 is raised to a predetermined pressure in the event of an internal short circuit or the like, the valve member 12 ruptures due to the pressure. This activates the valve mechanism. Upon activation of the valve mechanism, the gas within the case is discharged outside the battery through a gas escape route, the route including the second hole 6a of the insulating plate 6, the vent hole 13a of the second conductor plate 13, the vent hole 12a of the valve substrate 21, and the first hole 11a of the first conductor plate 11.

Here, the opening area S1 (mm²) and the opening area S2 (mm²) are set to satisfy the following inequality (1):

(3/t+12)mm²≦S1<S2 (1).

The coefficient t in the inequality (1) corresponds to a wall thickness (mm²) of the case 5. By setting the opening areas S1 and S2 with reference to a wall thickness of the case 5, the opening areas S1 and S2 can be appropriately set so that the case 5 will not deform extremely due to an increase in the internal pressure. Here, the coefficient t specifically corresponds to the wall thickness of a portion of the case 5 that covers the side of the electrode group 4 disposed between the insulating plates 6 and 7.

The first conductor plate 11 of the sealing unit 10 serves as a positive terminal of the battery as mentioned above. For this reason, the opening area S1 is preferably set as small as possible. More specifically, a preferable upper limit value UV of the opening area S1 is equal to a smaller one between the following two: an area which is 5% of a plane view area PS (e.g., an area of the battery viewed from its opening, mm²) of the first conductor plate, and an area which is 1.6 times as large as the lower limit value LV. For ensuring the strength that prevents the case 5 from rupturing when the case internal pressure increases abnormally, the wall thickness (coefficient t) of the case is preferably set to 0.1 mm or more. The internal volume of the case, however, decreases with increase in the wall thickness of the case 5. Therefore, the wall thickness of the case 5 is preferably 0.25 mm or less. There is no particular limitation on the shape and the number of holes of the first hole 11a of the first conductor plate 11. The same applies to the second hole.

Note that, with regard to the opening areas of the vent hole 13a of the second conductor plate 13 and the vent hole 12a of the valve substrate 22, the second conductor plate 13 and the valve substrate 12 are usually made of aluminum foil. The temperature of the gas generated in the event of an abnormality such as an internal short circuit is higher than the melting point of aluminum. Accordingly, the second conductor plate 13 and the valve substrate 12 easily melt by the gas. Therefore, as for the opening areas of the holes provided in them, a necessary area for discharging gas is quickly ensured. As a result, in the event of an abnormality, the gas discharge ability of the valve mechanism will be mainly restricted by the opening area S1 of the first hole 11a of the first conductor plate 11 made of iron. When the insulating plate included in the sealed battery is made of glass phenol, the insulating plate also will not melt because the melting point of glass is higher than the temperature of the generated gas. Note that, by setting of the opening area S2 larger than the opening area S1, the presence of the sealing plate will not restrict the gas discharge ability of the valve mechanism.

Example of the present invention will now be described. The following Example, however, should not be construed as limiting the present invention.

### EXAMPLE

A lithium ion secondary battery configured as below was fabricated as a sealed secondary battery. A slurry (positive electrode slurry) was prepared by dispersing a positive electrode active material comprising a lithium nickel oxide in which part of nickel was substituted by cobalt and aluminum, a binder comprising polyvinylidene fluorides (PVDF), and a conductive agent comprising acetylene black, into a dispersion medium. A positive electrode was produced by applying the positive electrode slurry onto a surface of a positive electrode current collector comprising aluminum, drying an applied film of the slurry, and then pressing the applied film.

A slurry (negative electrode slurry) was prepared by dispersing a negative electrode active material comprising graphite and a binder comprising styrene-butadiene rubber, into a dispersion medium. A negative electrode 2 was produced by applying the negative electrode slurry onto a surface of a negative electrode current collector comprising copper foil, drying an applied film of the slurry, and then pressing the applied film.

The positive and negative electrodes obtained as above were wound, with a polyethylene separator interposed therebetween, thereby to form a columnar electrode group. The electrode group was housed in a cylindrical case having an outer diameter of 18 mm, and an electrolyte was injected into the case. Thereafter, the opening of the case was sealed with a sealing unit via a gasket. In that way, a 18650-size lithium ion secondary battery was fabricated as the sealed secondary battery. The capacity of the battery was 2.86 Ah, and the amount of electric energy thereof was 10.3 Wh.

Here, a 0.4-mm-thick iron sheet, a 0.15-mm-thick aluminum sheet, and a 0.4-mm-thick aluminum sheet were respectively used as a first conductor plate, a valve member, and a second conductor plate constituting the sealing unit. A 0.3-mm-thick glass phenol resin was used as an insulating plate. The opening area S1 of a first hole of the first conductor plate and the opening area S2 of a second hole of the insulating plate (upper insulating plate) were varied to fabricate test batteries, and with respect to each test batteries, the battery safety was tested. The opening area S2 was equally set to 80 mm² across the test batteries.

In the safety test, the test batteries were heated to 200° C. by application of heat from outside, thereby to force the batteries into a thermal runaway state. Whether or not the case of each test battery extremely deformed or broke was checked.

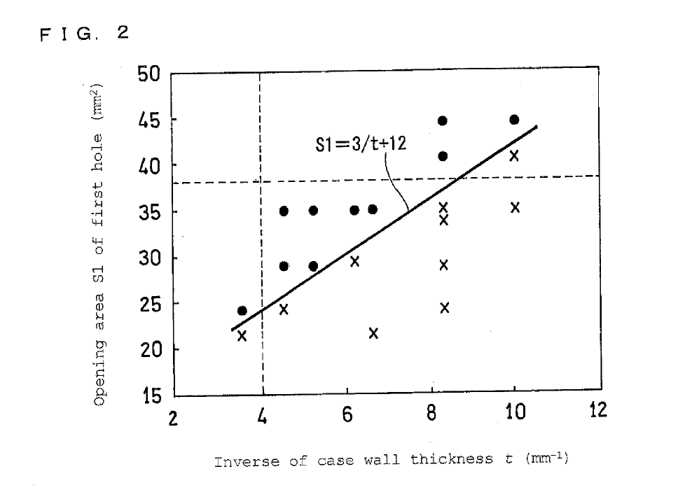

FIG. 2 is a graph of the results of the above test on the safety. The black dot in the figure represents the data of the test battery in which the case did not deform extremely. The x-mark represents the data of the test battery in which the case deformed or broke extremely.

As shown in FIG. 2, in the test batteries having the opening area S1 larger than (3/t+12) mm², the case did not deform extremely. In contrast, in the test batteries having the opening area S1 smaller than (3/t+12) mm², the case tended to deform extremely. The above results show that by setting the opening area S1 larger than (3/t+12) mm², even when a large amount of gas is generated within the battery in the event of an abnormality such as an internal short circuit, the gas can be quickly discharged to the exterior through the valve mechanism. The foregoing shows that when (3/t+12) mm²≦S1<S2, or (3/t+12) mm²<S1<S2, the safety of the sealed secondary battery can be improved.

Test batteries having a capacity of 2.6 Ah and an electric energy of 9.4 Wh were fabricated in a manner similar to the above. With respect to the test batteries, the battery safety was tested in the same manner as above. In this test also, in the test batteries in which the opening area S1 was larger than (3/t+12) (mm²), the case did not deform extremely. Note that the 18650-size sealed secondary battery whose energy density exceeds 10 Wh is an example of the sealed secondary battery having a volumetric energy density exceeding 600 Wh/L.

While the present invention is described above by way of preferable embodiments, the description is not to be construed as limiting the present invention, and various modifications can be made to the above-described embodiment within the scope of the present invention. For example, in the above embodiment, the description is made using a lithium ion secondary battery as the sealed secondary battery. The present invention, however, is not limited thereto, and can be applied to other non-aqueous electrolyte secondary batteries.

Furthermore, in the above embodiment, the description is made using an electrode group formed by spirally winding a positive electrode and a negative electrode, with a separator interposed therebetween. The electrode group, however, is not limited thereto, and may be an electrode group formed by stacking a positive electrode and a negative electrode, with a separator interposed therebetween. Moreover, in the above embodiment, a cylindrical secondary battery is used as an example of the sealed secondary battery. The present invention, however, is not limited thereto, and can be applied to, for example, a prismatic secondary battery.

### INDUSTRIAL APPLICABILITY

The present invention is useful as a driving power source for automobiles, motorbikes, motor toys or the like.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### REFERENCE SIGNS LIST

1: Positive electrode, 2: Negative electrode, 3: Separator, 4: Electrode group, 5: Case, 5a: Groove, 6: (Upper) Insulating plate, 6a: Second hole, 7: (Lower) Insulating plate, 8: Positive electrode lead, 9: Negative electrode lead, 10: Sealing unit, 11: First conductor plate, 11a: First hole, 12: Valve member, 12a, 13a: Vent hole, 13: Second conductor plate, 14: Gasket, 21: Valve substrate, 21a: Welding portion, 22: PTC element plate, 100: Battery, S1, S2: Opening area

1. A sealed secondary battery comprising:
an electrode group including a positive electrode, a negative electrode, and a separator;
a case housing the electrode group and having an opening;
an insulating plate disposed near the opening and between the opening and the electrode group within the case; and
a sealing unit sealing the opening of the case;
the sealing unit including a first conductor plate, a second conductor plate, and a valve member interposed between the first conductor plate and the second conductor plate, and being fitted to the opening of the case, with the first conductor plate disposed on an exterior side of the case and the second conductor plate disposed on an interior side of the case;
the first conductor plate having a first hole for passage of gas;
the insulating plate having a second hole for passage of gas;
the first hole having an opening area S1 (mm²), the second hole having an opening area S2 (mm²), S1 and S2 satisfying the following inequality:
(3/t+12)mm²≦S1<S2,
where a coefficient t corresponds to a wall thickness (mm) of the case.

2. The sealed secondary battery according to claim 1, wherein the coefficient t corresponds to the wall thickness of the case of 0.1 mm or more and 0.25 mm or less.

3. The sealed secondary battery according to claim 1, wherein
the first conductor plate and the valve member each include aluminum, and
the second conductor plate includes iron.

4. The sealed secondary battery according to claim 1, wherein the sealed secondary battery has an energy density of 600 Wh/L or more.

5. The sealed secondary battery according claim 1, wherein the electrode group is a columnar electrode group including the positive electrode and the negative electrode wound with the separator interposed between the positive electrode and the negative electrode, and the case has a cylindrical shape.
